(19) United States
(12) Patent Application Publication
(10) Pub. No.: US 2002/0029165 A1
(43) Pub. Date: Mar. 7, 2002

(54) Automatic fare adjustment system and memory device for transportation system

(76) Inventors: Sunao Takatori, Tokyo (JP); Hisanori Kiyomatsu, Tokyo (JP)

Correspondence Address: MYERS BIGEL SIBLEY & SAJOVEC, PO BOX 37428, RALEIGH, NC, 27627, US

(21) Appl. No.: 09/947,265

(22) Filed: Sep. 5, 2001

(30) Foreign Application Priority Data
Sep. 6, 2000 (JP) 270032/2000

(51) Int. Cl. G06F 17/60

(52) U.S. Cl. 705/13

(57) ABSTRACT

An automatic fare adjustment system is provided for train systems for which more than on service provider operates trains. It is possible to prevent illegal use of a memory device. The memory device 10 stores ID information and information about settling methods, fare imposition, free transportation sections that are covered by commuter passes, coupon tickets, etc, and travel history. A transmitter 20 at an automatic ticket gate for boarding 1 sends information about the boarding station to the memory device 10. Onboard a train, information about an intermediate station is sent from an onboard transmitter 30 to the memory device 10. A fare imposing unit 40 at an automatic ticket gate for detraining 4 carries out fare imposition processing based on the above-described information and information about boarding and intermediate stations. The transmitter 20 and the fare imposing unit 40 send information stored in the memory device 10 to a host computer 50, where the information is compared with the information about settling methods and travel history stored in the host computer 50 to make sure that the particular memory device is valid.

### BACKGROUND OF THE INVENTION

1. Field of the Invention

The present invention relates to an automatic fare adjustment system for public transportation such as commuter train systems.

2. Description of the Related Art

At the present, various types of prepaid magnetic cards are used widely. Such cards are used as follows. A user passes a magnetic prepaid card through an automatic ticket examination machine at a boarding station, the automatic ticket examination machine reads fare imposition information by using a magnetic reading system. When the amount recorded in the fare imposition information on this card exceeds the basic fare, the amount equivalent to the basic fare is subtracted from the amount recorded in the fare imposition information, and information about the boarding station is recorded. When the user passes this card through an automatic ticket examination machine at a detraining station, the automatic ticket examination machine reads the information about the boarding station recorded on the card, and subtracts the amount obtained by subtracting the already subtracted amount for the basic fare from the amount equivalent to the fare for riding from the boarding station to the detraining station in the fare imposition information recorded on the card.

With this method, unless information about the boarding station is recorded, automatic fare adjustment is not made at the detraining station. For example, when both commuter pass and prepaid card are to be used, the fare adjustment has to be made once on an automatic fare adjustment machine using the commuter pass and the prepaid card, and then a fare adjusted ticket issued by the fare adjustment machine is inserted in an automatic ticket examination machine. Therefore, this method is inconvenient.

Also, since the fare is calculated based only on the information about the boarding and detraining stations, some problems may arise. For example, if more than one service provider (such as a combination of a private company and a public corporation) serves railroad lines, a plurality of routes can be used from the boarding station to the detraining station with different fares for different routes, and it may be difficult to deal with such fare differences properly. Such a problem hinders the widespread use of common prepaid cards issued and used by a plurality of service providers.

Further, the available periods of the present commuter pass are one month, three months, and six months, and when the period expires, a new commuter pass must be purchased. If the available period is made remarkably long to save troubles in purchasing a pass, it is more difficult to take measures against loss, forgery, and the like.

### SUMMARY OF THE INVENTION

Accordingly, an object of the present invention is to provide an automatic fare adjustment system and a memory device for transportation systems, which can be used together with existing commuter passes and coupon tickets.

Another object of the present invention is to provide an automatic fare adjustment system and a memory device for transportation systems, which can easily be used for railroad lines on which a plurality of service providers run their trains.

Still another object of the present invention is to provide an automatic fare adjustment system and a memory device for transportation, which are effective in taking measures against loss and illegal use such as forgery of passes or tickets.

To achieve the above object, the present invention provides an automatic fare adjustment system comprising a memory device having a signal transmission/reception function, which stores information concerning identification (ID), settling methods, and free transportation sections; a first transmitter having a signal transmission/reception function which is provided in the vicinity of an automatic ticket gate for boarding to send information about the boarding station to the memory device; a second transmitter for sending information about an intermediate station to the memory device; and a fare imposing unit having a signal transmission/reception function which is provided in the vicinity of an automatic ticket gate for detraining to carry out fare imposition processing by receiving the information concerning ID, settling methods, free transportation sections, the boarding, and intermediate stations from the memory device.

In the present invention, the memory device further stores travel history information; the system has a host computer connected to the first transmitter and the fare imposing unit, which stores travel history information for each ID of memory device; and the host computer makes judgment as to whether or not the memory device is valid by comparing the travel history information stored in the memory device with the travel history information for the ID of the memory device stored in the host computer.

Also, in the present invention, the host computer stores information about a settling method for the ID of each memory device, and makes judgment as to whether or not the memory device is valid by comparing the information about the settling method stored in the memory device with the information about the settling method for the particular ID of the memory device stored in the host computer.

Further, the present invention provides a memory device for transportation having a signal transmission/reception function which stores information concerning ID, settling methods, free transportation sections and travel history, and receives information about the boarding and intermediate stations from an outside unit to store the information.

Still further, in the present invention, the memory device further has an input section and an output section, and is provided with a function of comparing information about a station inputted through the input section with information about the station received from the outside unit and outputting a rusult of the comparison to the output section.

### BRIEF DESCRIPTION OF THE DRAWINGS

FIG. 1 is a schematic view for illustrating the outline of an automatic fare adjustment system in accordance with the present invention;

FIG. 2 is a view showing a configuration and stored information of a memory device for transportation sysytem in accordance with the present invention;

FIG. 3 is a block diagram showing configurations of a transmitter, an onboard transmitter, and a fare imposing unit;

FIG. 4 is a block diagram showing a configuration of a host computer;

FIG. 5 is a flowchart for illustrating processing at an automatic ticket gate for boarding;

FIG. 6 is a flowchart for illustrating processing in a train;

FIG. 7 is a flowchart for illustrating processing at an automatic ticket gate for detraining;

FIG. 8 is a view for illustrating one example of fare calculation; and

FIG. 9 is a view showing a configuration of another embodiment of a memory device for transportation in accordance with the present invention.

### DETAILED DESCRIPTION OF THE PREFERRED EMBODIMENTS

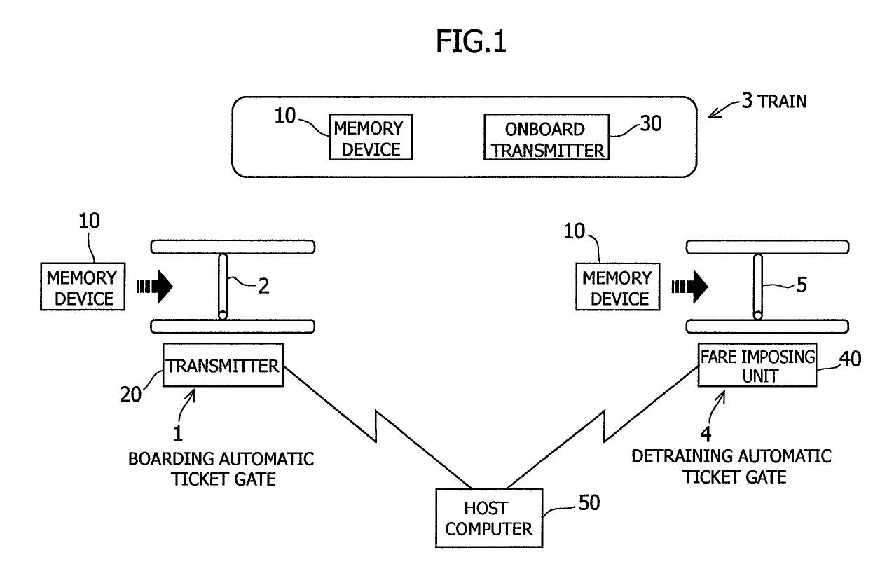

First, a schematic configuration of an automatic fare adjustment system for public transportation in accordance with the present invention will be described with reference to FIG. 1. In this embodiment, descriptions will be made for a track-type passenger transportation system such as train systems as a typical example for public transportation.

FIG. 1 shows the vicinity of an automatic ticket gate for boarding, the inside of a vehicle (in this figure, a train), and the vicinity of an automatic ticket gate for detraining. In FIG. 1, reference numeral 10 denotes a memory device having a transmission/reception function. A user carries this memory device 10. As described later, in the memory device 10 are recorded various pieces of information such as ID information and information about settling methods, fare imposition, free transportation sections for sections validly covered by a commuter pass or a coupon ticket, and travel history. As the memory device 10, any device can be used if it has a function of transferring the above-described information to and from the outside unit and can store the information so as to be capable of rewriting it. For example, a non-contact type IC card, a contact-type IC card, a magnetic stripe card, and other various devices can be used. However, as described later, a device having an information transfer means of a non-contact type is preferred.

As shown in FIG. 1, a transmitter 20 is provided in the vicinity of an automatic ticket gate for boarding 1 so that various pieces of information are transferred between the memory device 10 and the transmitter 20. The automatic ticket gate for boarding 1 also has a gate door 2. Also, on the inside of a train 3, an onboard transmitter 30 is provided. In the vicinity of a terminal station throough which a plurality of railroad lines extend, information about an intermediate station is sent from the onboard transmitter 30 to the memory device 10 and is written on the memory device 10. Further, in the vicinity of an automatic ticket gate for detraining 4, a fare imposing unit 40 is provided. Various pieces of information are transferred between the fare imposing unit 40 and the memory device 10 so that fare adjustment is made, and the opening/closing control of a gate door 5 is accomplished. Also, the transmitter 20 and the fare imposing unit 40 are connected, via a communication line, to a host computer 50 operated by a service provider.

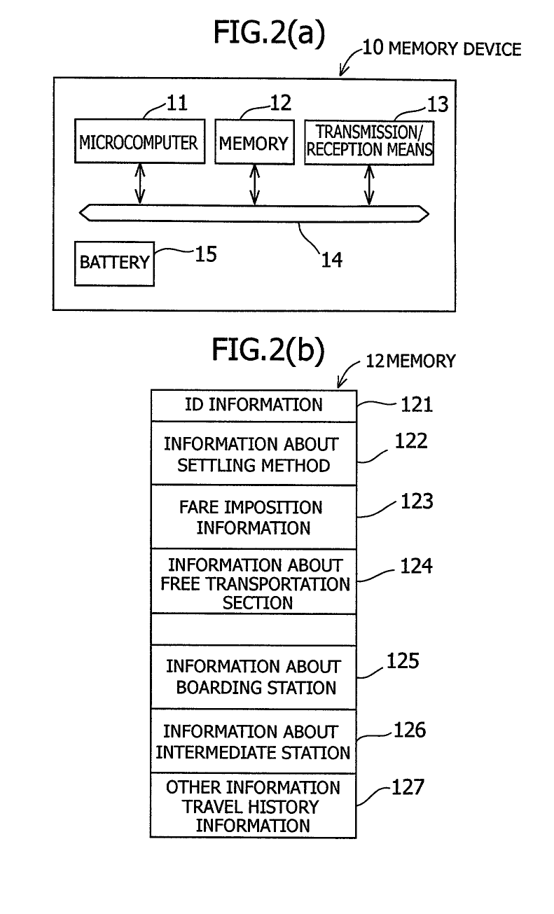

A configuration of the memory device 10 will be described with reference to FIG. 2. FIG. 2a is a block diagram showing one example of the configuration of the memory device 10, and FIG. 2b is a view for illustrating information recorded in the memory device 10.

In FIG. 2a, a controller 11 for controlling the memory device 10 consists of a microcomputer incorporating a program ROM storing, for example, a control program and a RAM used as a work area and the like. Further, the memory device 10 has a memory 12 for storing various pieces of information; a transmission/reception means 13 for transferring information to and from the transmitter 20, the onboard transmitter 30, and the fare imposing unit 40; a bus 14; and a battery 15. As the transmission/reception means 13, various systems can be used regardless of whether contact type or non-contact type.

As shown in FIG. 2b, the memory 12 is provided with regions for storing various pieces of information, such as a region 121 for storing ID information, a region 122 for storing information about a settling method, a region 123 for storing fare imposing information, a region 124 for storing information about free transportation sections, a region 125 for storing information about a boarding station sent from the transmitter 20, a region 126 for storing information about an intermediate station received from the onboard transmitter 30, and a region 127 for storing other information such as travel history information which will be described later.

The ID information stored in the region 121 is necessary to identify the user of the memory device 10 to prevent its illegal use.

Also, the information (settlement information) about a settling method stored in the region 122 is information about a settling method selected arbitrarily by the user of the memory device. This information indicates which one of various settling methods is used, the various settling method including (1) what is called a prepaid method in which an amount of money applied to a given fare is deposited with the service provider in advance, and fare imposition information concerning the amount is recorded, (2) a settling method in which fare is collected through financial service such as a credit card, a debit card, and the like, and (3) a post payment method in which fare imposition information is recorded in the host computer of the corporation, and the fare is collected by money transfer, bank account transfer, manual money collection, and the like. The settling method is not limited to the above-described three methods.

The fare imposition information stored in the region 123 is information about what is called a remainder which is an amount obtained by subtracting the already spent amount for fares from the amount deposited with the service provider in advance if the above-described prepaid method of item (1) is selected as a settling method.

Further, the information about free transportation sections stored in the region 124 is about free rides given by specifying the period or the number of rides in transportation sections used frequently, for example, to go for work or school by paying a specified amount of money in advance to purchase a commuter pass or a coupon ticket. This information includes sections and available periods or available numbers of rides without further charges.

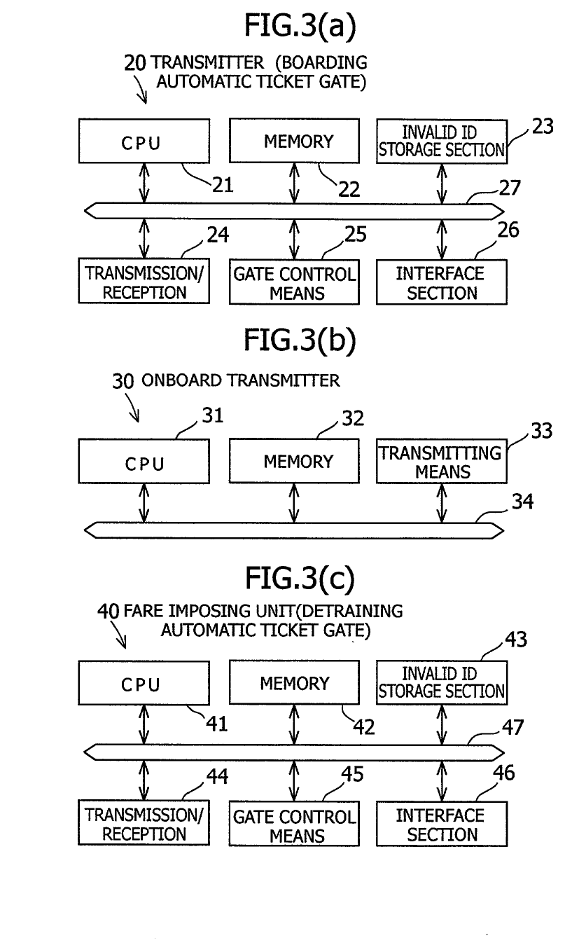

FIG. 3 is a block diagram showing configurations of the transmitter 20, the onboard transmitter 30, and the fare imposing unit 40.

FIG. 3a shows a configuration of the transmitter 20 provided in the vicinity of the automatic ticket gate for boarding 1. The transmitter 20 includes a CPU 21 for controlling the operation of the transmitter 20, a memory 22 for storing a control program and various pieces of information such as information about a boarding station at which the transmitter 20 is provided, an invalid ID memory section 23 for storing information about invalid ID sent from the host computer 50, a transmission/reception section 24 for transferring various pieces of information to and from the memory device 10, a gate control means 25 for controlling the opening and closing of the gate door 2 of the automatic ticket gate for boarding 1, an interface section 26 for connecting the transmitter 20 to the host computer 50, and a bus 27. The invalid ID is stored in the invalid ID memory section of all of the transmitters 20 and the fare imposing units 40 via the host computer 50 when the user reports that he/she has lost his/her memory device 10, for example.

FIG. 3b shows a configuration of the onboard transmitter 30 provided in the train 3. The onboard transmitter 30 includes a CPU 31 for controlling the operation of the onboard transmitter 30, a memory 32 for storing a control program and information about the intermediate station, a transmitting means 33 for sending the information about the intermediate station to the memory device 10, and a bus 34.

FIG. 3c is a block diagram showing a configuration of the fare imposing unit 40 provided in the vicinity of the automatic ticket gate for detraining 4. The fare imposing unit 40 includes a CPU 41 for controlling the operation of the fare imposing unit 40, a memory 42 for storing a control program, a fare calculation program, and various pieces of information, an invalid ID memory section 43 for storing information about invalid ID sent from the host computer 50, a transmission/reception section 44 for transferring various pieces of information to and from the memory device 10, a gate control means 45 for controlling the opening and closing of the gate door 5 of the automatic ticket gate for detraining 4, an interface section 46 for communicating with the host computer 50, and a bus 47.

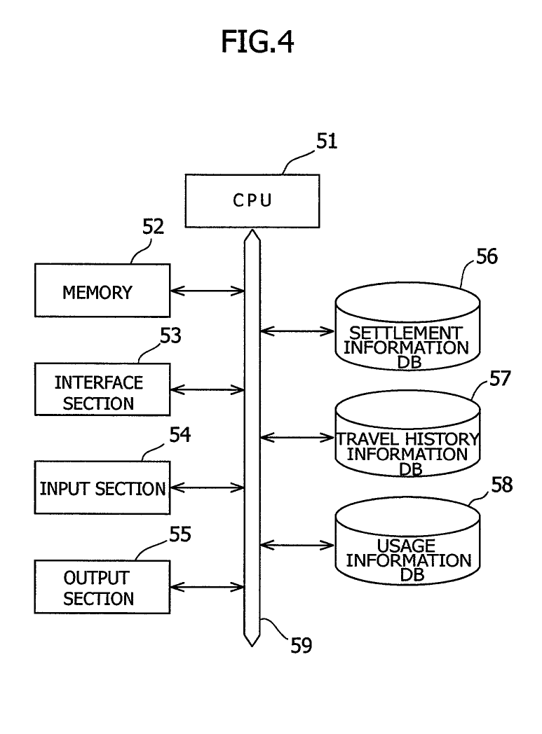

FIG. 4 is a block diagram showing one example of a configuration of the host computer 50. The host computer 50 includes a CPU 51 for controlling the operation of the whole of the host computer 50, a memory 52, an interface section 53 for transferring information between the transmitter 20 and the fare imposing unit 40 provided at stations, an input section 54, an output section 55, and a bus 59. Also, the host computer 50 has a settlement information database 56 storing information about the settling method for each ID information, a travel history information database 57 storing travel history information of each recorder 10 for each ID information, which is sent from the transmitter 20 and the fare imposing unit 40, and a usage information database 58 storing usage information of transportation for each ID information, which is likewise sent from the transmitter 20 and the fare imposing unit 40. The content of the settlement information database 56 is written on the memory device 10 when the memory device 10 is issued.

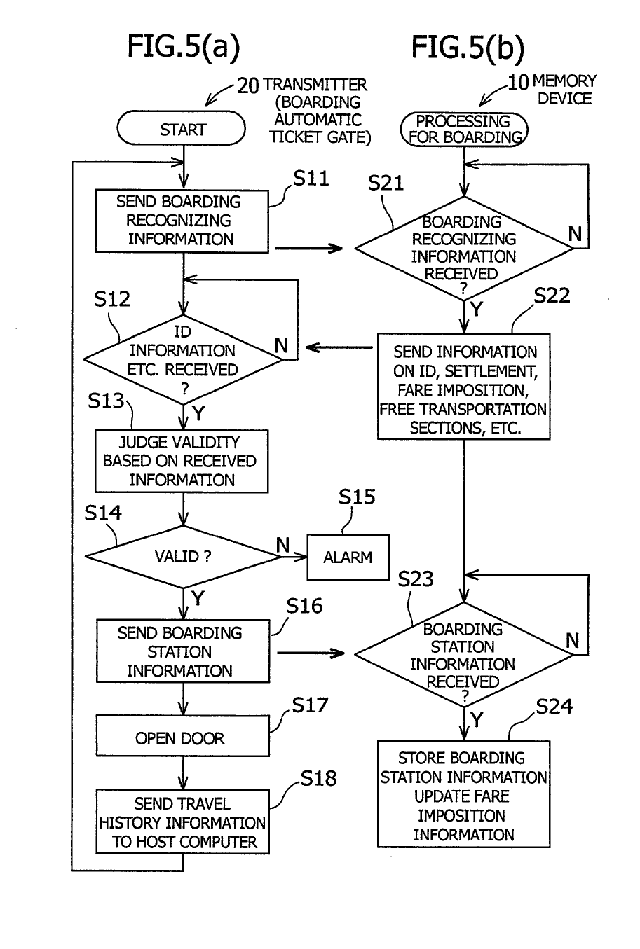

The operation of the automatic fare adjustment system for public transportation in accordance with the present invention, which is configured as described above, will be described with reference to flowcharts of FIGS. 5 to 7.

First, the operation in the case where a user carrying the memory device 10 approaches the automatic ticket gate for boarding 1 as shown in FIG. 1 will be described with reference to FIG. 5. FIG. 5a is a flowchart showing a flow of processing in the transmitter 20, and FIG. 5b is a flowchart showing a flow of processing in the memory device 10.

As shown in FIG. 5a, the transmitter 20 sends information (boarding recognizing information) necessary for recognizing the memory device 10 (Step S11).

On the other hand, when the memory device 10 receives the boarding recognizing information sent from the transmitter 20 (Step S21), the memory device 10 sends various pieces of information necessary for judging whether or not boarding is allowed, such as the ID information, fare imposition information, settlement information, and travel history information (Step S22).

In Step S12, the transmitter 20 having received this signal proceeds to Step S13, where it is judged whether or not the user carrying the memory device 10 is allowed to ride a train. This judgment is made in one of two modes. One mode is such that the judgment is made in the transmitter 20, and the other is such that information necessary for the judgment is sent to the host computer 50, and the host computer 50 makes the judgment, a result of which is received by the transmitter 20.

First, in the transmitter 20, judgments as to whether or not the ID information received agrees with the invalid ID stored in the invalid ID memory section 23, whether or not the remainder in the fare imposition information is equal to or larger than the fare equivalent to the basic fare in the case where the prepaid method of item (1) is selected as a settling method, and whether or not the boarding station is within a valid free transportation section, and other judgments are made.

Also, the ID information, settlement information, and fare imposition information received from the memory device 10 are sent to the host computer 50 via the interface section 26, and are compared with the settlement information and fare imposition information stored in the settlement information database 56 in the host computer 50. As the result of this comparison, if a disagreement occurs, the host computer 50 judges that the memory device 10 has been forged and is invalid, and sends information to that effect to the transmitter 20.

Further, the travel history information received from the memory device 10 is also sent to the host computer 50, and is compared with the travel history information of the ID information stored in the travel history information database 57 in the host computer 50. As the result of this comparison, if a disagreement occurs as well, the host computer 50 judges that the memory device 10 has been forged, and sends information to that effect to the transmitter 20.

As the result of these judgments (Step S14), if it is judged that the memory device 10 is invalid, an alarm is set off, for example, by giving out a special sound without the gate door 2 being opened (step S15). On the other hand, if it is judged that the memory device 10 is valid, the transmitter 20 sends information about boarding station to the memory device 10 (Step S16), and drives the gate control means 25 to open the automatic ticket gate (Step S17). Then, the transmitter 20 sends the information about boarding station together with the ID information to the host computer 50 (Step S18). The host computer stores these pieces of information in the travel history information database 57.

On the other hand, the memory device 10 receives the information about boarding station sent in Step S15 (Step S23), and stores the information about boarding station in the region 125 of the memory 12. Also, when the prepaid method is selected as a settling method, the amount equivalent to the basic fare is subtracted from the fare imposition information recorded in the region 123 (Step S24).

Thereby, the user carrying the memory device 10 can pass through the automatic ticket gate for boarding 1.

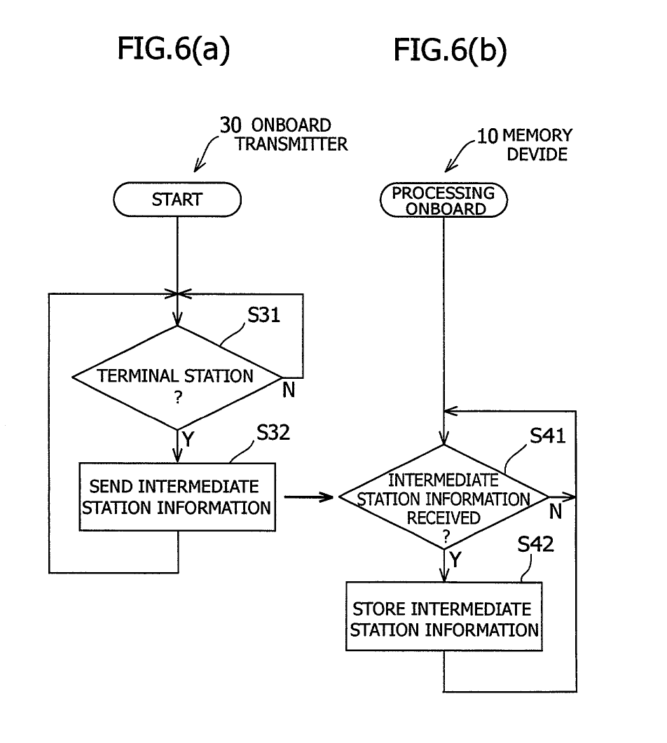

Next, the operations of the onboard transmitter 30 in a train and the memory device 10 will be described with reference to a flowchart of FIG. 6. FIG. 6a shows the operation of the onboard transmitter 30, and FIG. 6b shows the operation of the memory device 10.

In FIG. 6a, when the train on which the user carrying the memory device 10 rides passes what is called a terminal station to which a plurality of railroad lines extend (Step S31), the onboard transmitter 30 sends information about a passing terminal station on route (intemediate station) to the memory device 10 (Step S32).

The memory device 10 receives the information about the intermediate station (Step S41), and stores the received information about the intermediate station in the region 126 (FIG. 2) of the memory 12 (Step S42).

When traveling through a plurality of terminal stations, information about each intermediate station is stored in succession in the region 126.

When the memory device 10 in the train can receive a signal from a transmitter provided on a platform of a station, instead of providing the onboard transmitter 30 in a train as described above, at each terminal station may be provided a transmitter for sending information about that station (that is, an intermediate station).

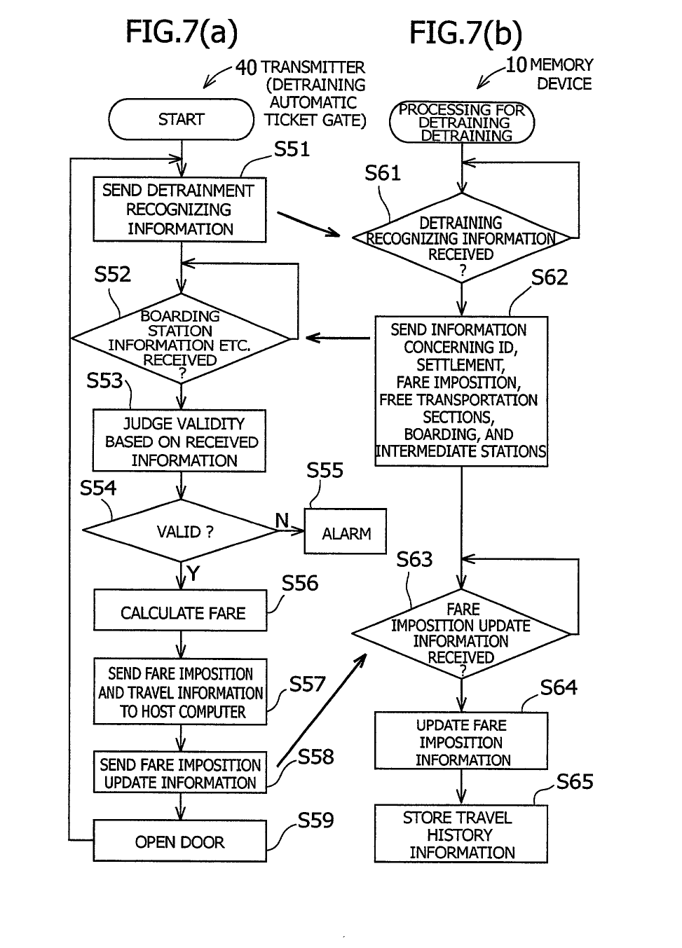

Next, the operations of the fare imposing unit 40 provided at the automatic ticket gate for detraining 4 and the memory device 10 will be described with reference to a flowchart of FIG. 7. FIG. 7a shows the operation of the fare imposing unit 40, and FIG. 7b shows the operation of the memory device 10.

As shown in FIG. 7a, the fare imposing unit 40 sends information (detrainment recognizing information) necessary for recognizing the memory device 10 (Step S51). This detrainment recognizing information contains information about detraining station (station ID).

When the memory device 10 receives the detrainment recognizing information (Step S61), it sends various pieces of information necessary for fare imposition, such as the ID information, and information concerning the boarding station, intermediate stations, free transportation sections, settling methods, and fare imposition, which are stored in each region of the memory 12, to the fare imposing unit 40 (Step S62).

After receiving signals from the memory device 10 in Step S52, the fare imposing unit 40 judges whether or not the memory device 10 is valid based on the received information. For some information, the judgment is made by the fare imposing unit 40, and for other information, judgment is made by the host computer 50 after information necessary for judgment is sent to the host computer. In the fare imposing unit 40, it is judged whether or not the received ID information agrees with the ID stored in the invalid ID memory section 43. Also, the ID information, settlement information, fare imposition information, information about boarding station, travel history information, and the like, which are received from the memory device 10 are sent to the host computer 50 via the interface section 46, and are compared with the information stored in the settlement information database 56 and the information stored in the travel history information database 57. As the result, if a disagreement occurs, it is judged that the memory device 10 is invalid, and information to that effect is sent to the fare imposing unit 40.

As a result of the above-described judgment (Step S54), when it is judged that the memory device 10 is invalid, an alarm is set off, for example, by giving out a special sound without the gate door 5 being opened (Step S55). On the other hand, if it is judged that the memory device 10 is valid, the fare imposing unit 40 automatically calculates a fare to be imposed on the user based on the information about boarding and intermediate stations, free transportation sections, and fare imposition which is received from the memory device 10 (Step S56).

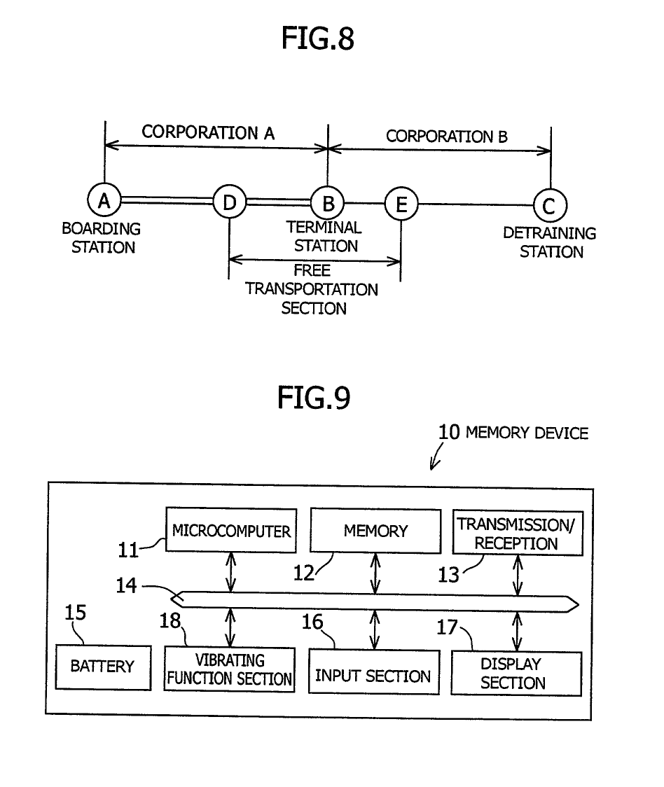

For example, it is assumed that as shown in FIG. 8, the boarding station is Station A, the intermediate station is Station B, and the detraining station is Station C; the section between Stations A and B is operated by Corporation A, and the section between Stations B and C is operated by Corporation B; a section between Station D lying between Stations A and B and Station E lying between Stations B and C is recorded as the free transportation section; and a promise that x yen is deducted from the fare in the case of mutual extension of service is made between Corporations A and B. In this case, the fare imposing unit 40 automatically calculates (1) the fare between Stations A and B plus the fare between Stations B and C minus X, and (2) the fare between Stations A and D plus the fare between Stations E and C, and makes calculation so that a cheaper amount of (1) or (2) is imposed.

The processing for calculating the fare may be performed by the host computer 50.

After the fare to be imposed is calculated as described above, the fare imposing unit 40 proceeds to Step S57, where processing for imposing the fare is performed by the selected settling method, and the travel information is sent to the host computer 50. This travel information is stored in the travel history information database 57.

When the prepaid method of item (1) is selected, fare imposition update information obtained by subtracting the amount equivalent to the basic fare from the fare calculated in Step S56 is sent to the memory device 10. In response to this, the memory device 10 updates the fare imposition information stored in the memory 12 (Steps S63 and S64). Also, the memory device 10 stores the information about boarding station stored in the region 125 and the information about the intermediate station stored in the region 126, together with the information about the detraining station contained in the detrainment recognizing information sent from the fare imposing unit 40, in the region 127 as travel history information (Step S65).

Also, when the settling method in which fare is collected by financial service such as a credit card of item (2) is selected, and when the post payment method of item (3) is selected, the ID information and information about the calculated fare etc. are sent to the host computer 50, and are stored in the usage information database 58. The information stored in the usage information database 58 is read out on every predetermined date, and processing for payment to a financial service company or financial organization is carried out.

Next, the fare imposing unit 40 proceeds to Step S59, where the gate control means 45 is driven to open the gate door 5 of the automatic ticket gate for detraining 4.

Thereby, the user can go out of the station.

In the above-described embodiment, the judgment processing (processing of comparison with the settlement information database 56 and the travel history information database 57) done by the host computer 50 in Step S13 in FIG. 5 and in Step S53 in FIG. 7 is carried out in real time. However, the comparison processing may be carried out in a batch mode outside the business hours.

In this case, if the use of a forged card is found, that ID is sent to all of the transmitters 20 and the fare imposing units 40, and is recorded in the invalid ID memory sections 23 and 43. Thereby, the forged card cannot be used on and after the following day.

By taking measures to prevent the memory device 10 from being used illegally, protection against forgery, theft, and loss of the memory device 10 can be achieved effectively.

Also, it is possible to have a plurality of settling methods stored in the memory device 10. In this case, the settling method registered by the user as a preferred method may normally be used, and it is possible for the user to select another settling method, when the user performs a specific operation. For example, prepaid information is recorded as one settling method, and a settling method by transfer form a bank account of the user's employer as another settling method, and when the user selects the settling method by transfer from the bank account, the fare is transferred from the bank account of the user's employer. Thereby, the train fares used for business can be adjusted and settled smoothly.

Further, the memory device 10 is not limited to the above-described configuration.

FIG. 9 shows another embodiment of the memory device 10. In the memory device 10 of this embodiment, an input section 16, a display section 17 serving as an output section, and a vibrating function section 18 are added to the memory device 10 shown in FIG. 2a.

Information about a station at which the user is going to get off a train is inputted to the memory device 10 through the input section 16. Each time the train arrives at a station, the onboard transmitter 30 sends information about that station to the memory device 10. When the memory device 10 receives information about the station at which the train is stopping, the display section 17 presents display to that effect.

Also, by inputting the station at which the user is going to get off a train through the input section 16, when the train arrives at that station, the information about the station at which the train is stopping, which is sent from the onboard transmitter 30, is compared with the inputted information about the station at which the user is going to get off the train, with which the vibrating function section 18 is activated, or the display section 17 presents display to the effect that the user should get off the train.

According to this embodiment, an announcement about a station at which the train arrives, which is made in the train, can be eliminated.

Further, the memory device 10 can be provided with a function of automatically calculating an advantageous railroad route in terms of time and cost based on the information about boarding and detraining stations. In this case, the configuration can be such that when the train arrives at the transfer station, detraining station, or the like, the user's attention is aroused by the vibrating function section 18 or the display section 17 or both.

Further, the memory device 10 can be mounted on a cellular phone. The input section, display section, vibrating function section, and the like of the cellular phone can be used as those for the memory device 10. If the cellular phone meets a requirement for Internet connection service, by connecting the cellular phone to a railroad line retrieval service via the internet connection service and by inputting information about the place where the user is at present and information about the user's destination, the nearest station and the most appropriate railroad route are retrieved, and information about the transfer station etc. can be transferred to the memory device 10.

Although the present invention has been described by taking a track-type passenger transit system such as a train system, which is a typical example of public transportation, as an example in the above-described embodiments, the present invention is not limited to this means. For example, the present invention can be applied to an automatic expressway toll adjustment method known as an ETC system, a bus, and the like.

As described above, according to the automatic fare adjustment system and the memory device for transportation in accordance with the present invention, since information about free transportation sections covered by a commuter pass or a coupon ticket is stored, a function of commuter passes and coupon tickets can additionally be performed using the system of the present invention.

Also, since information about intermediate stations is stored in the onboard transmitter, the present invention can be applied to the railroad route on which a plurality of service providers run their trains, so that a system common to plurality of service providers can be realized.

Further, since collation with settlement information and travel history information are checked, protection against loss, forgery, and the like can be achieved.

The entire disclosure of Japanese Patent Application No. 2000-270032 filed on Sep. 6, 2000, including specification, claims, drawings and summary are incorporated herein by reference in its entirety.

1. An automatic fare adjustment system comprising:
a memory device having a signal transmission/reception function which stores ID information, and information about a settling method and a free transportation section;
a first transmitter having a signal transmission/reception function, which is provided in the vicinity of a boarding-side automatic ticket gate to send information about boarding station to said memory device;
a second transmitter for sending information about an intermediate station to said memory device; and
a fare imposing unit having a signal transmission/reception function which is provided in the vicinity of a detraining automatic ticket gate to carry out fare imposition processing by receiving said ID information and information about the settling method, free transportation sections, boarding station and intermediate stations from said memory device.

2. The automatic fare adjustment system according to claim 1, wherein said memory device further stores travel history information;
said system has a host computer connected to said first transmitter and said fare imposing unit, which host computer stores travel history information for each ID of memory device; and
said host computer judge as to whether or not said memory device is valid by comparing the travel history information stored in said memory device with the travel history information of the ID of said memory device stored in said host computer.

3. The automatic fare adjustment system according to claim 1 or 2, wherein said host computer stores information about settling method for the ID of each memory device, and makes judgment as to whether or not said memory device is valid by comparing the information about settling method stored in said memory device with the information about settling method of the ID of said memory device stored in said host computer.

4. A memory device for a transportation system having a signal transmission/reception function, which stores ID information, information about a settling method, a free transportation section, and travel history, and receives information about boarding and intermediate stations from an outside unit and stores said information.

5. The memory device for a transportation system according to claim 4, wherein said memory device further has an input section and an output section, and is provided with a function of comparing information about a station inputted through said input section with information about the station received from said outside unit and of outputting the comparison result on said output section.
